(19) United States
(12) Patent Application Publication
(10) Pub. No.: US 2019/0215363 A1
(43) Pub. Date: Jul. 11, 2019

(54) DYNAMIC POOL-BASED TIERING FOR SYNCHRONIZATION STORAGE

(71) Applicant: SOFTNAS OPERATING INC., Houston, TX (US)

(72) Inventor: Eric OLSON, Melbourne, FL (US)

(73) Assignee: SOFTNAS OPERATING INC., Houston, TX (US)

(21) Appl. No.: 16/242,648

(22) Filed: Jan. 8, 2019

Related U.S. Application Data
(60) Provisional application No. 62/614,941, filed on Jan. 8, 2018.

(51) Int. Cl. H04L 29/08

(52) U.S. Cl. CPC H04L 67/1095; G06F 16/183; H04L 67/06; H04L 67/1097

(57) ABSTRACT

Dynamic pool-based tiering is provided for a file system including a plurality of storage priority tiers each comprising one or more storage pools and associated volumes. Received data is written to a selected priority tier. Based on one or more transfer criteria, it is determined that a given data item stored in a source volume of a first priority tier should be transferred out of the first tier. The transfer criteria include a number of times the given data item has been accessed and an interaction history of the given data item. Based on an analysis of the transfer criteria, a target volume within a second priority tier of the file system where the given data item can be transferred to is identified. The given data item is transferred to the target volume of the second priority tier, and is removed from the source volume within the first priority tier.

### CROSS-REFERENCE TO RELATED APPLICATIONS

This application claims priority to U.S. Provisional Application No. 62/614,941 filed Jan. 8, 2018 and entitled “FLEXIBLE POOL BASED TIERING IN A SYNCHRONIZATION STORAGE SOLUTIONS”, which is hereby incorporated by reference in its entirety.

### TECHNICAL FIELD

The subject matter herein generally relates to synchronization storage solutions, and more specifically to flexible and dynamic pool-based tiering in synchronization storage solutions.

### BACKGROUND

Different types of data can have different storage requirements based on one or more intended uses of the stored data. For example, data that serves only as a backup and will be accessed infrequently, if at all, will likely have very different storage requirements than data that is accessed hundreds or thousands of times per day. While different storage technologies have evolved to meet a wide variety of data storage needs across a range of price vs. performance characteristics, these storage technologies are not dynamic or adaptable in the sense that an end user or enterprise's decision-making capability extends only to their initial purchase decision. In other words, after a certain storage technology is selected, the end user or enterprise is typically unable to easily, or in a cost-effective manner, scale out of or shift their data to a different storage technology in response to changing data storage or performance needs.

Manual data migrations can be performed to shift stored data from a first storage technology to a second storage technology, but this is a cumbersome and expensive process that often results in undesirable downtime for the end user or enterprise. Conventional solutions attempt to supplement the purely manual data migration process by offering various time-saving measures, but such solutions typically automate existing human processes and do not address the underlying issue of providing dynamic adaptation to changing data storage needs without disrupting existing data flows and data usage patterns.

### BRIEF DESCRIPTION OF THE DRAWINGS

Implementations of the present technology will now be described, by way of example only, with reference to the attached figures, wherein:

FIG. 1 is an example of a possible system architecture implementing the current disclosed subject matter;

FIG. 2A is a block diagram of an example flexible tier system;

FIG. 2B is a block diagram of an example of data transferred between tiers of an example flexible tier system;

FIG. 3 is a block diagram of another example of a flexible tier system; and

FIG. 4 is an example system architecture.

### DETAILED DESCRIPTION

For simplicity and clarity of illustration, where appropriate, reference numerals have been repeated among the different figures to indicate corresponding or analogous elements. In addition, numerous specific details are set forth in order to provide a thorough understanding of the implementations described herein. However, the implementations described herein can be practiced without these specific details. In other instances, methods, procedures and components have not been described in detail so as not to obscure the related relevant feature being described. Also, the description is not to be considered as limiting the scope of the implementations described herein.

Various examples of the disclosure are discussed in detail below. While specific implementations are discussed, it should be understood that this is done for illustration purposes only. The terms “e.g.” and “i.e.” are used to show specific examples for illustration and contextual purposes only and should not be considered limiting. As such, specific examples are not limiting, but merely provide a contextual basis for present disclosure. The present disclosure also includes the use of one or more of the examples, but not other ones of the examples. A person skilled in the relevant art will recognize that other components and configurations may be used without parting from the scope of the disclosure.

The terminology used in the description of the invention herein is for the purpose of describing particular embodiments only and is not intended to be limiting of the invention. As used in the description of the invention and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

The term “comprising”, which is synonymous with “including,” “containing,” or “characterized by” is inclusive or open-ended and does not exclude additional, unrecited elements or method steps. “Comprising” is a term of art used in claim language which means that the named elements are present, but other elements can be added and still form a construct or method within the scope of the claim.

Several definitions that apply throughout this disclosure will now be presented. The term coupled is defined as directly or indirectly connected to one or more components. The term server can include a hardware server, a virtual machine, and a software server. The term server can be used interchangeably with the term node. ZFS is a combined file system and logical volume manager designed by Sun Microsystems. The features of ZFS include protection against data corruption, support for high storage capacities, efficient data compression, integration of the concepts of file system and volume management, snapshots and copy-on-write clones, continuous integrity checking and automatic repair, RAID-Z and native NFSv4 ACLs. A pool is defined as one or more data storage devices such as disks aggregated to create a unit of storage. Secure Shell (SSH) is a cryptographic network protocol for secure data communication, remote command-line login, remote command execution, and other secure network services between two networked computers that connects, via a secure channel over an insecure network, a server and a client (running SSH server and SSH client programs, respectively). The protocol specification distinguishes between two major versions that are referred to as SSH-1 and SSH-2, both of which are comprised by SSH within this disclosure. Certain aspects of this disclosure pertain to public-key cryptography. Public-key cryptography, also known as asymmetric cryptography, is a class of cryptographic algorithms which requires two separate keys, one of which is secret (or private) and one of which is public. Although different, the two parts of this key pair are mathematically linked. The public key is used to encrypt plaintext or to verify a digital signature; whereas the private key is used to decrypt ciphertext or to create a digital signature. The term “asymmetric” stems from the use of different keys to perform these opposite functions, each the inverse of the other—as contrasted with conventional (“symmetric”) cryptography which relies on the same key to perform both. Public-key algorithms are based on mathematical problems which currently admit no efficient solution that are inherent in certain integer factorization, discrete logarithm, and elliptic curve relationships. It is computationally easy for a user to generate their own public and private key-pair and to use them for encryption and decryption. The strength lies in the fact that it is “impossible” (computationally infeasible) for a properly generated private key to be determined from its corresponding public key. Thus the public key may be published without compromising security, whereas the private key must not be revealed to anyone not authorized to read messages or perform digital signatures. Public key algorithms, unlike symmetric key algorithms, do not require a secure initial exchange of one (or more) secret keys between the parties.

In at least one embodiment, the present technology can be implemented as a software module or a hardware module, or both. In at least one embodiment, the present technology causes a processor to execute instructions. The software module can be stored within a memory device or a drive. The present technology can be implemented with a variety of different drive configurations including Network File System (NFS), Internet Small Computer System Interface (iSCSi), and Common Internet File System (CIFS). Additionally, the present technology can be configured to run on VMware ESXi (which is an operating system-independent hypervisor based on the VMkernel operating system interfacing with agents that run on top of it. Additionally, the present technology can be configured to run on Amazon® Web Service in VPC, Microsoft Azure, or any other cloud storage providers.

The present technology is configured to provide fast and user-friendly ways to add powerful storage replication, backup and disaster recovery to data management systems. In at least one embodiment, the system of the present technology provides real-time block replication for failover and business continuity, and for site-to-site data transfers such as region-to-region data replicas across Amazon EC2 data centers, Microsoft Azure data centers, or VMware failover across data centers.

In at least one embodiment, data is replicated from a source server to a target server. The present technology is configured for efficient scaling, which can enable it to handle replication of millions of files quickly and efficiently.

Unlike conventional clustered file systems, at least one embodiment of the present technology uses block replication, which sends the changed data blocks from source to target. This block replication avoids the need to perform wasteful, resource-intensive file comparisons, since any time the contents of a file are updated, the copy-on-write file system keeps track of which data blocks have changed and sends the changed blocks between two snapshot markers per a period of time, which can be one minute, or less.

The present technology is configured to enable fast and easy methods to quickly configure a complete replication and disaster recovery solution in very short periods of time, often no more than one. The automated methods within the technology avoid the need for complex scripting and detailed user-input and/or instructions.

In at least one embodiment of the present technology, replication can be configured between two controllers, a source server on the one hand, and a target server on the other. In at least one embodiment of the technology, a synchronization relationship between the source server and the target server is established. The synchronization relationship can be quickly and easily created for disaster recovery, real-time backup and failover, thereby ensuring that data on the source server is fully-protected at an off-site location or on another server or VM, for example, at another data center, a different building or elsewhere in the cloud. Processes described herein streamline the entire replication setup process, thereby significantly reducing error rates in conventional systems and making the replication process more user friendly than in conventional systems.

At least one embodiment of the present technology is a method of establishing a synchronization relationship between data storage nodes in a system. The method can include providing access to at least one source server via a user-interface, where the source server is configurable to store at least one source storage pool and at least one source volume. The method can also include receiving an internet protocol address of at least one target server, where the target server is configurable to store at least one target storage pool and at least one target volume. The method can also include: receiving log-in credentials corresponding to the at least one target server; providing access to the at least one target server, based on the received log-in credentials; and establishing a replication relationship between the nodes. Establishing a replication relationship can include: creating at least one public key; creating at least on private key; authorizing two-way communication between the nodes via at least one secure connection (e.g., secure shell); exchanging the at least one public key between the nodes; and confirming two-way communication between the nodes via at least one secure connection (e.g., secure shell). The method can also include automatically discovering the information present on both nodes necessary to achieve replication; including determining at least which storage pools and volumes need to be replicated. Such determination can involve automatically discovering the storage pools on the nodes that have a same name; automatically discovering the volumes in each such storage pool; automatically configuring tasks necessary for each volume to be replicated; automatically determining whether a full back-up or synchronization from the source server to the target server of all storage pools and volumes in the source server is necessary; and executing the full back-up or synchronization from the source server to the target server of all storage pools and volumes in the source server, upon such determination. The method can also further include performing a data replication once per minute. The data replication can involve synchronizing data on the source server to the target server which has changed within the last two minutes.

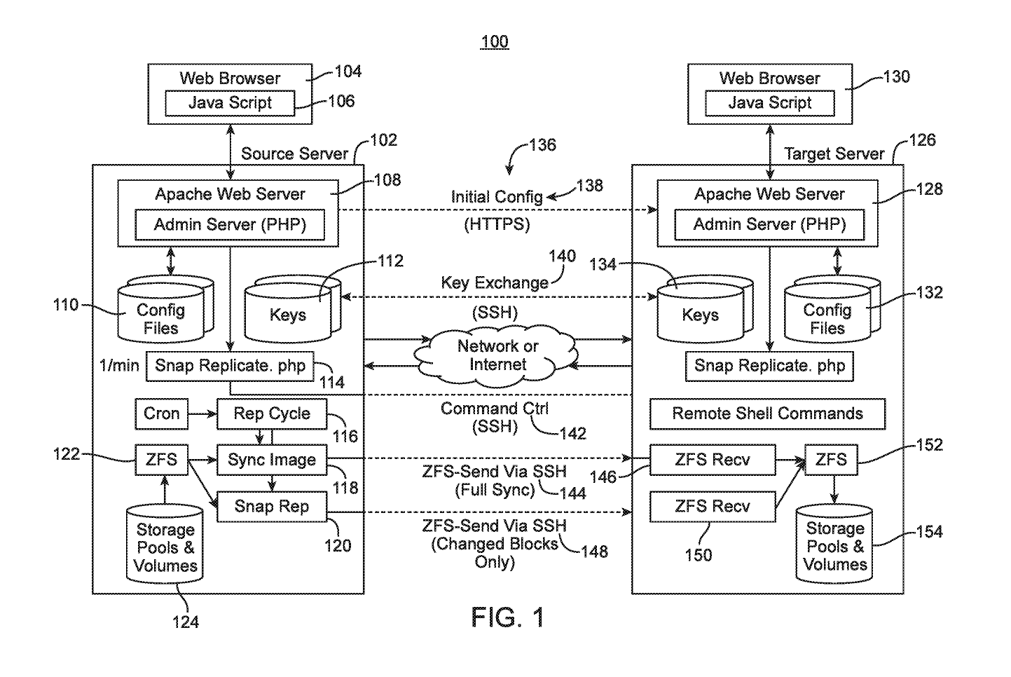

FIG. 1 is an example of a possible system architecture 100 in which one or more aspects of the present disclosure may be implemented. At the highest level, system architecture 100 consists of a source server 102 and a target server 126. Web browsers 104 and 130 are also shown as being associated with source server 102 and target server 126, respectively.

The source server 102 can be in signal communication with a device running web browser 104. As illustrated, web browser 104 can be associated with one or more programs or JavaScript components 106. The web browser 104 can be used to implement and transmit commands and instructions to source server 102 and to receive information from source server 102. The source server 102 can include or otherwise be coupled to an Apache Web Server 108. As shown, the Apache Web Server 108 can be coupled to a storage unit 110 storing one or more configuration files. Source server 102 can further include at least one storage unit 112 storing keys. The keys stored by storage unit 112 which can be public keys, private keys, or both. As shown, the Apache Web Server 108 can control a replicate device or process 114. In some examples, the replicate process 114 can be executed at one or more predetermined intervals, for example, once every minute as shown in FIG. 1. The replicate process 114 can include a replication cycle 116 and can further include a sync image process 118 and a replicate process 120. The sync image process 118 and the replicate process 120 can be controlled by a file system and logical volume manager such as ZFS 122. ZFS 122 can manage the sync image process 118 and the replicate process 120 with respect to data in storage pools and volumes corresponding to the source server 102 or Apache Web Server 108.

Also shown in FIG. 1 is a target server 126. Target server 126 can contain or be in communication with an Apache Web Server 128, and may additionally be in signal communication with a web browser. Target server 126 can contain or be coupled to a data storage unit 132 containing one or more configuration files. Target server 126 can also contain or be coupled to a data storage unit 134 containing public keys, private keys, or both. The Apache Web Server 128 can control replicate processes on target server 126. The source server 102 and the target server 126 can be configured for two-way communication. Accordingly, the Apache Web Server 108 corresponding to the source server 102 can send initial configuration instructions to the Apache Web Server 128 of the target server 128. Two-way communication path 136 also enables the exchange of keys between the servers (102, 126), and enables control commands 142 to be transmitted from the source server 102 to the target server 126. Two-way communication 136 further enables ZFS 122 to send full sync commands and data 144 to a ZFS receiver 146 on the target server 126 and enables ZFS 122 to send replicate commands and data 148 to a second ZFS receiver of the target server 126. In some embodiments, a ZFS unit 152 of the target server 126 updates the storage pools and volumes 154 of the target server with the received ZFS data (144, 148), thereby synchronizing them with the storage pools and volumes 124 of the source server 102.

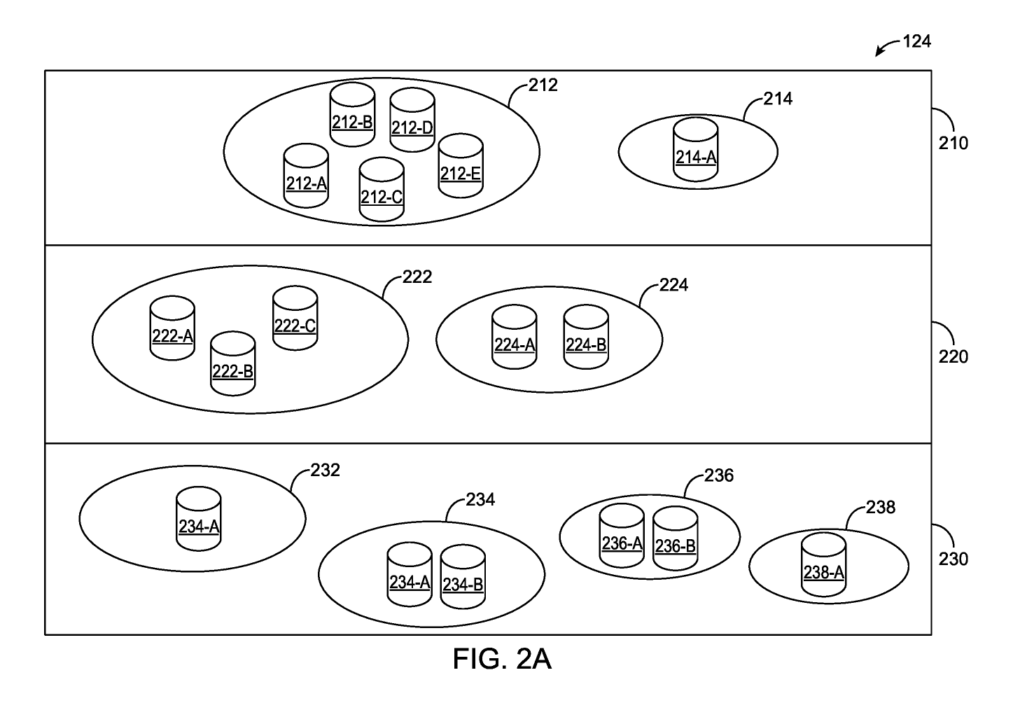

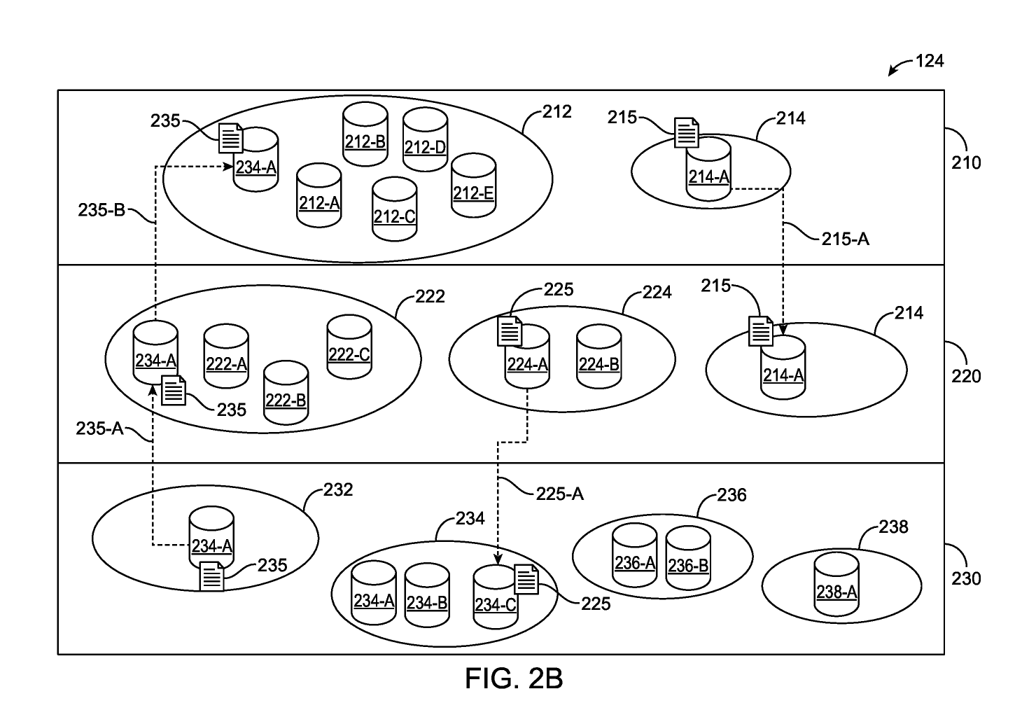

FIG. 2A illustrates a detailed view of storage pools and volumes 124. In some embodiments, one or more of storage pools and volumes 124 may be configured as ZFS storage pools and volumes. Storage pools and volumes 124 can include one or more tiers, for example, tier 210, tier 220 and tier 230. The one or more tiers can each be associated with one or more priority levels, for example, tier 210 can be a high priority tier, tier 220 can be a medium or standard priority tier, and tier 230 can be a low or archive priority tier. The high priority tier 210 can include, but is not limited to, data that was recently written to the storage pools and volumes 124 (e.g. within a predetermined threshold such as the last 30 days, etc.), data that was recently read, data that has been frequently read (e.g. over a predetermined number of times, etc.), data that was specifically marked as high priority, etc. In some embodiments, the high priority tier 210 can be physically located on high-end or cache-like hardware (e.g., for more expedient access, etc.). The high priority tier 210 can also be, for example, block-based storage.

In some examples, tier 220 can be a medium or standard priority tier. The standard priority tier 220 can include, but is not limited to, data that was initially written without an assigned priority (e.g., its metadata did not specify any priority level), data that was written outside of a predetermined threshold (e.g., the last 30 days, etc.), data that was last read outside of a predetermined number of days, data that has been infrequently read (e.g. under a predetermined number of times, etc.), etc.

In some example, tier 230 can be a low priority tier or archive tier. The low priority tier 230 can include archived data, for example, data that was last accessed (e.g., written or read) outside of a larger predetermined threshold than that of either the high priority tier 210 or the medium priority tier 220 (e.g., 90 days, etc.). The low/archive priority tier 230 can be, for example, provided as object-based storage.

In some embodiments, each tier can be configured as its own dedicated ZFS storage pool. The tiers can also be created based on the number of available types of based public cloud storage pools. That is, the tiers can be created for the available types of storage pools available from public cloud storage offerings (e.g., AWS, Azure, etc.). As such, the tiers can be created in an ad hoc fashion, across multiple ZFS storage pools based on one or more configuration parameters (e.g., manual configurations, frequency of scans, modifications of blocks, etc.)

The one or more tiers (e.g., 210, 220, 230, etc.) can each have one or more constituent pools. The one or more pools can be created manually or automatically and assigned to a tier. For example, as illustrated, high priority tier 210 contains pools 212 and 214; standard priority tier 220 contains pools 222 and 224; and low priority tier 230 contains pools 232, 234, 236, and 238. In some examples, a pool can be reassigned to a different tier (e.g., where all volumes and data within that pool are also reassigned, etc.).

Each pool can have one or more volumes. For example, high priority tier 210 contains pool 212 which consists of volumes 212-A, 212-B, 212-C, 212-D, 212-E, although it is appreciated that a greater or lesser number of volumes can be utilized without departing from the scope of the present disclosure. Each volume can store a plurality of data files, types, etc, (e.g., blocks, files, folders, databases, data structures, etc.). The volumes can be identical or different from one another.

FIG. 2B illustrates a detailed view of data (e.g., files, blocks, folders, etc.) being moved between tiers. As described above, data can move between tiers in response to a number of criteria (e.g., reads, writes, metadata, etc.). In some scenarios, data can move between one tier at a time, for example, between low priority tier 230 and standard priority tier 220, but not between low priority tier 230 and high priority tier 210. In other examples, data can move between any tiers, for example, between low priority tier 230 and standard priority tier 220, but also between low priority tier 230 and high priority tier 210.

In some examples, data can be initially written into a specified storage tier, pool, and/or volume based on data type. For example, data (e.g., 235) that is to be initially archived (e.g., email, etc.) can be directly written into low priority tier 230 (e.g., archive tier). In another example, data (e.g., 215, 225) that is categorized as standard could be written into either the high priority tier 210 or the medium priority tier 220, depending on factors such as storage configuration and preferences of the one or more users. In another example, data (e.g., 215) that is categorized as a high priority can be written directly into the high priority tier 210.

Once data has been initially written to a tier, the data can be transferred between tiers based on specific criteria. The transfer between tiers can be automatic based on the criteria (e.g., rules, etc.), can be based on interactions with the data (e.g., reads, writes, etc.) or any combination thereof. When data is transferred between tiers, the data can be transferred to a previously existing volume and/or storage pool or a volume and/or storage pool can be newly created. In some examples, the destination volume and/or storage pool in which the data will be newly stored can be created in the tier the data is to be transferred. Each of these scenarios is shown in FIG. 2B. The transfer between tiers can be carried out by one or more computer-implemented methods, instructions stored on non-transitory memory executed by one or more processors, or a system.

With continued reference to FIG. 2B, in one embodiment data 235 can be initially written in volume 234-A of storage pool 232 of archive tier 230. As such, data 235 can be considered archive data and of low priority. In some instances, data 235 can become a higher priority and can be moved to a higher priority tier (e.g., tier 220 or tier 210). For example, when data 235 stored in the archive tier 230 is read, the data 235 can be transferred (e.g., 235-A) to standard priority tier 220 (e.g., volume 234-A of storage pool 222) in response to having been read. In this example, volume 234-A can be created and assigned in storage pool 222 for the purpose of receiving the data 235. In other examples, the transfer 235-A to standard priority tier 220 can be performed after a predetermined number of read requests for data 235 are received or executed. Upon transfer to standard priority tier 220, data 235 can be removed from volume 234-A of storage pool 232 of archive tier 230. In some examples, although not shown, data 235 can later be transferred back to archive tier 230 after a predetermined amount of time elapses (e.g., predefined period, or a predetermined amount of time over which data 235 is not accessed, etc.).

In further examples, data 235 might become high priority data (e.g., high number of reads are requested/observed, fast reads become necessary, etc.). In these situations, data 235 can be transferred (e.g., 235-B) to high priority tier 210 (e.g., volume 234-A of storage pool 212). In this example, volume 234-A can be created and assigned in storage pool 212. In some examples, the transfer 235-B can be initiated when a predetermined threshold is met (e.g., number of reads, etc.), metadata of data 235 has been updated with a priority flag, etc. Although not shown, data 235 can also be transferred back to tier 220, for example, after a specified amount of time elapses, e.g., without a threshold number of read requests being met, in response to the removal of a priority flag, etc. In some examples, data 235 can go directly from archive priority tier 230 to high priority tier 210.

In other examples, data (e.g., 215) can be written directly to a volume (e.g., 214-A) of a storage pool (e.g., 214) of the high priority tier (e.g., 210). In some examples, all newly written data is written in the high priority tier 210, at which point the data remains in the high priority tier 210 if it is flagged as high priority or if it is accessed a sufficient number of times to meet the high priority threshold. If neither of these conditions are met, then the data can tier-down into a lower priority tier (i.e. trickle/expires down from high priority to standard priority, from standard priority to archive priority, or from high priority to archive priority, etc.).

In other examples, data with metadata defining the data as high priority is written in the high priority tier 210 and all other data will be initially written in the medium priority tier 220 (e.g., unless the metadata defines the data at a low or archive priority, in which case such data will be initially written in the archive priority tier 230). Data stored in the high priority tier 210 can be transferred (e.g., 215-A) to a lower priority tier (e.g., standard priority tier 220) when certain criteria are met, for example, after a specified amount of time elapses (e.g., 30 days, 60 days, etc.). In some examples, the amount of time can be contingent on access or number of reads of the data (e.g., last time accessed, amount of time accessed, etc.). As shown in FIG. 2B, in response data 215 can be transferred to volume 214-A of storage pool 214 of standard priority tier 220. In this example, storage pool 214 and volume 214-A can be created in standard priority tier 220 prior to the transfer of data 215.

In some examples, data (e.g., 225) can be stored in the standard priority tier (e.g., tier 220). In some examples, all newly written data (without a high or low priority designation in its metadata) can be written to standard priority tier 220. In other examples, data can be initially stored in standard priority tier 220 when a standard designation (e.g., in metadata, etc.) is assigned to the data. Data stored in the standard priority tier 220 can be transferred (e.g., 225-A) to a lower priority tier (e.g., archive priority tier 230) when certain criteria are met, for example, after a specified amount of time elapses (e.g., 30 days, 60 days, etc.). In some examples, the amount of time can be contingent on access of the data (e.g., last time accessed, amount of time accessed, etc.). As shown in FIG. 2B, data 225 can be transferred from volume 224-A of storage pool 224 of standard priority tier 220, to volume 234-C of storage pool 234 of archive priority tier 230 (and volume 234-C could be newly created or could have previously existed in the storage pool 234).

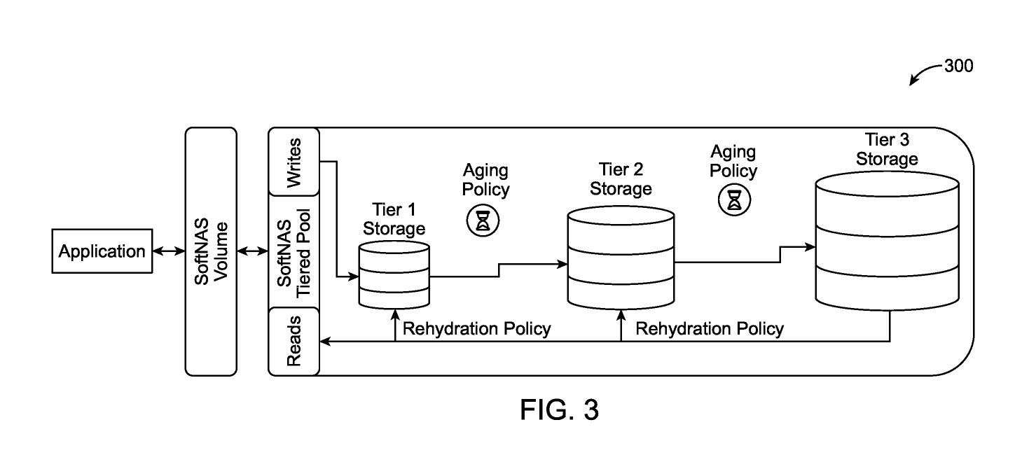

FIG. 3 depicts an embodiment of a flexible tier system 300 according to aspects of the present disclosure. In this example, applications can access the volumes (via tiered storage pool) of the flexible tier system similar to how they would access any other volume via NFS or CIFS. The tiered storage pool can, for example, consist of up to 4 tiers with each tier comprising a different type of storage (e.g., cloud storage, block storage, object storage, etc.). Data (e.g., of any type—object or block) can be transferred (or rehydrated) to other tiers (e.g., object tier, block tier, hybrid tier, any combination thereof, etc.).

Writes to the tiered storage system 300 can be initially written to tier 1 storage, which in some embodiments can be backed by the highest performance cloud storage (and likely the most expensive). For example, data written to tier 1 is likely to be accessed before data written at a previous time. As such, tier 1 data can have the highest performance storage. Aging policies can be set to determine how long data will reside on a tier before it is transferred to the next tier. For example, after a predetermined period of time (e.g., 30 days, etc.) data can be transferred from tier 1 storage to tier 2 storage. Later or lower tier storage (e.g., tier 2 storage, tier 3 storage, etc.) can consist of lower cost and/or lower performance cloud storage. For example, data written to tier 2 or tier 3 is less likely to be accessed before data written to tier 1.

Reads to the tiered storage system 300 can retrieve data by retrieving each requested block of data from the specific tier in which the given block currently resides. For example, a file could have its blocks spread across multiple tiers, and as such, a read from an application may have to retrieve blocks from multiple tiers to satisfy the read.

Data can be transmitted back to higher tiers through rehydration policies. Rehydration policies can be configured to transfer frequently accessed data (e.g., blocks of data, objects, etc.) from a lower tier to a higher tier (e.g., high performance tier) in response to certain events, conditions, triggers, etc. For example, a rehydration policy can be configured such that if data (whether block, object, or other) is accessed a predetermined number of times within a certain period of time (e.g., two or more times in two minutes, etc.), the block can be transferred to the next highest tier (e.g., from tier 2 to tier 1, tier 3 to tier 2, etc.). In a block storage example, rehydration of blocks can move up one tier at a time, for example, blocks on tier 3 will not move right to tier 1 but must first pass through tier 2. In other examples, blocks can move between multiple tiers without any requirement of direct or progressive travel.

While the present embodiment discusses data in terms of volumes and pools being moved between tiers, it is also contemplated that entire volumes or pools can be moved between tiers based on one or more of the above mentioned criteria. It is also contemplated in block configurations that entire blocks can be transferred between tiers based on modifications or access of the block.

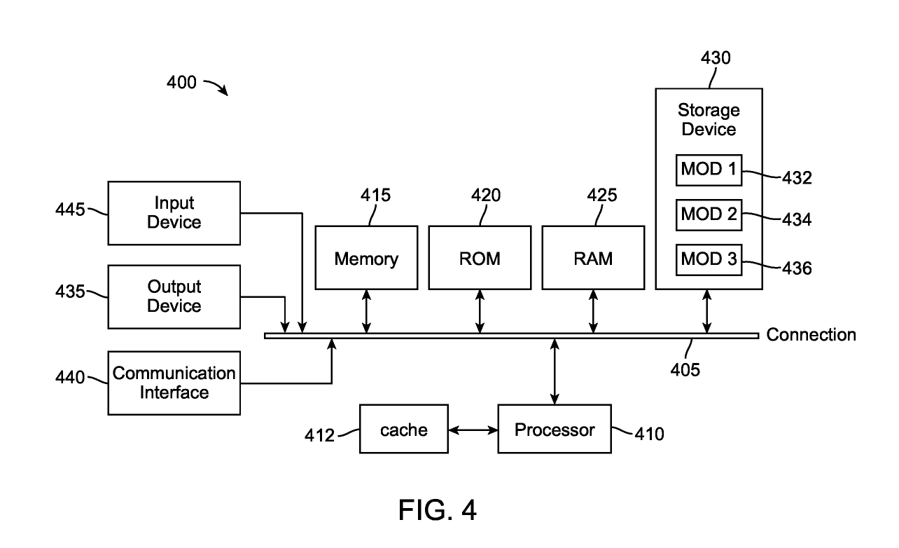

FIG. 4 shows an example of computing system 400 in which the components of the system are in communication with each other using connection 405. Connection 405 can be a physical connection via a bus, or a direct connection into processor 410, such as in a chipset or system-on-chip architecture. Connection 405 can also be a virtual connection, networked connection, or logical connection.

In some embodiments computing system 400 is a distributed system in which the functions described in this disclosure can be distributed within a datacenter, multiple datacenters, a peer network, throughout layers of a fog network, etc. In some embodiments, one or more of the described system components represents many such components each performing some or all of the function for which the component is described. In some embodiments, the components can be physical or virtual devices.

Example system 400 includes at least one processing unit (CPU or processor) 410 and connection 405 that couples various system components including system memory 415, read only memory (ROM) 420 or random access memory (RAM) 425 to processor 410. Computing system 400 can include a cache of high-speed memory 412 connected directly with, in close proximity to, or integrated as part of processor 410.

Processor 410 can include any general purpose processor and a hardware service or software service, such as services 432, 434, and 436 stored in storage device 430, configured to control processor 410 as well as a special-purpose processor where software instructions are incorporated into the actual processor design. Processor 410 may essentially be a completely self-contained computing system, containing multiple cores or processors, a bus, memory controller, cache, etc. A multi-core processor may be symmetric or asymmetric.

To enable user interaction, computing system 400 includes an input device 445, which can represent any number of input mechanisms, such as a microphone for speech, a touch-sensitive screen for gesture or graphical input, keyboard, mouse, motion input, speech, etc. Computing system 400 can also include output device 435, which can be one or more of a number of output mechanisms known to those of skill in the art. In some instances, multimodal systems can enable a user to provide multiple types of input/output to communicate with computing system 400. Computing system 400 can include communications interface 440, which can generally govern and manage the user input and system output, and also connect computing system 400 to other nodes in a network. There is no restriction on operating on any particular hardware arrangement and therefore the basic features here may easily be substituted for improved hardware or firmware arrangements as they are developed.

Storage device 430 can be a non-volatile memory device and can be a hard disk or other types of computer readable media which can store data that are accessible by a computer, such as magnetic cassettes, flash memory cards, solid state memory devices, digital versatile disks, cartridges, battery backed random access memories (RAMs), read only memory (ROM), and/or some combination of these devices.

The storage device 430 can include software services, servers, services, etc., that when the code that defines such software is executed by the processor 410, it causes the system to perform a function. In some embodiments, a hardware service that performs a particular function can include the software component stored in a computer-readable medium in connection with the necessary hardware components, such as processor 410, connection 405, output device 435, etc., to carry out the function.

Examples within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other examples of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Examples may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. Various modifications and changes may be made to the principles described herein without following the example embodiments and applications illustrated and described herein, without departing from the scope of the disclosure.

1. A system comprising:
a processor;
a file system including a plurality of storage priority tiers, each storage priority tier comprising one or more storage pools and associated volumes; and
a memory having instructions therein, which when executed by the processor cause the processor to:
write the received data to a selected priority tier of the plurality of storage priority tiers, the selection based on at least an analysis of the received data;
determine, based on one or more transfer criteria, that a given data item stored in a source volume of a first priority tier of the file system should be transferred out of the first priority tier, wherein the one or more transfer criteria include a number of times that the given data item has been accessed and an interaction history of the given data item;
identify, based on an analysis of the one or more transfer criteria, a target volume within a target storage pool of a second priority tier of the file system where the given data item can be transferred to;
transfer the given data item to the target volume within the target storage pool of the second priority tier; and
remove the given data item from the source volume within the first priority tier.

2. The system of claim 1, wherein the one or more transfer criteria further include a number of times that the given data item has been accessed over a pre-determined time interval and an elapsed time since the given data item was last accessed.

3. The system of claim 2, wherein the given data item is transferred out of the first priority tier in response to a determination that the one or more transfer criteria of the given data item do not satisfy one or more threshold levels associated with the first priority tier.

4. The system of claim 3, wherein the first priority tier has a greater priority than the second priority tier, and the one or more threshold levels associated with the first priority tier are specified by an aging policy.

5. The system of claim 4, further comprising converting the given data item from a data block to a data object when the given data item is transferred out of the first priority tier and into the second priority tier based on the aging policy.

6. The system of claim 3, wherein the first priority tier has a lesser priority than the second priority tier, and the one or more threshold levels associated with the first priority tier are specified by a rehydration policy.

7. The system of claim 6, further comprising converting the given data item from a data object to a data block when the given data item is transferred out of the first priority tier and into the second priority tier based on the rehydration policy.

8. The system of claim 3, wherein the second priority tier where the given data item can be transferred to is identified based on a determination that the transfer criteria of the given data item satisfy one or more threshold levels associated with the second priority tier.

9. The system of claim 1, wherein:
the plurality of storage priority tiers includes at least a high priority storage tier, a standard priority storage tier, and a low priority storage tier; and
the one or more storage pools of the plurality of storage priority tiers include a block storage pool and an object storage pool.

10. The system of claim 1, wherein the instructions further cause the processor to newly generate and assign one or more of the target volume and the target storage pool in the second priority tier before transferring the given data item from the first priority tier to the target volume of the second priority tier.

11. The system of claim 1, wherein the instructions further cause the processor to apply a metadata flag to the given data item when the given data item is transferred from the first priority tier to the second priority tier, wherein the metadata flag indicates a priority level or storage policy associated with the second priority tier.

12. The system of claim 1 where the file system comprises one or more EFS (Elastic File System) storage pools and associated volumes, or comprises one or more ZFS (Z File System) storage pools and associated volumes.

13. At least one non-transitory storage medium having stored therein instructions, which when executed by a processor cause the processor to:
receive data for storage in a file database, the file database including a plurality of storage priority tiers, each storage priority tier comprising one or more storage pools and associated volumes;
write received data to a selected priority tier of the plurality of storage priority tiers, the selection based on at least an analysis of the received data;
determine, based on one or more transfer criteria, that a given data item stored in a source volume of a first priority tier of the file database should be transferred out of the first priority tier, wherein the one or more transfer criteria include a number of times that the given data item has been accessed and an interaction history of the given data item;
identify, based on an analysis of the one or more transfer criteria, a target volume within a target storage pool of a second priority tier of the file database where the given data item can be transferred to;
transfer the given data item to the target volume within the target storage pool of the second priority tier; and
remove the given data item from the source volume within the first priority tier.

14. The at least one non-transitory storage medium of claim 13, wherein:
the one or more transfer criteria further include a number of times that the given data item has been accessed over a pre-determined time interval and an elapsed time since the given data item was last accessed; and
the instructions further cause the processor to transfer the given data item out of the first priority tier in response to a determination that the one or more transfer criteria of the given data item do not satisfy one or more threshold levels associated with the first priority tier.

15. The at least one non-transitory storage medium of claim 14, wherein:
the first priority tier has a greater priority than the second priority tier;
the one or more threshold levels associated with the first priority tier are specified by an aging policy; and
the instructions further cause the processor to convert the given data item from a data block to a data object when the given data item is transferred out of the first priority tier and into the second priority tier based on the aging policy.

16. The at least one non-transitory storage medium of claim 14, wherein:
the first priority tier has a lesser priority than the second priority tier;
the one or more threshold levels associated with the first priority tier are specified by a rehydration policy; and
the instructions further cause the processor to convert the given data item from a data object to a data block when the given data item is transferred out of the first priority tier and into the second priority tier based on the rehydration policy.

17. The at least one non-transitory storage medium of claim 13, wherein:
the plurality of storage priority tiers includes at least a high priority storage tier, a standard priority storage tier, and a low priority storage tier; and
the one or more storage pools of the plurality of storage priority tiers include a block storage pool and an object storage pool.

18. The at least one non-transitory storage medium of claim 13, wherein the instructions further cause the processor to newly generate and assign one or more of the target volume and the target storage pool in the second priority tier before transferring the given data item from the first priority tier to the target volume of the second priority tier.

19. The at least one non-transitory storage medium of claim 13, wherein the instructions further cause the processor to apply a metadata flag to the given data item when the given data item is transferred from the first priority tier to the second priority tier, wherein the metadata flag indicates a priority level or storage policy associated with the second priority tier.

20. The at least one non-transitory storage medium of claim 13, wherein the instructions cause the processor to execute, on the file database, one or more EFS (Elastic File System) storage pools or one or more ZFS (Z File System) storage pools.
